(19) United States
(12) Patent Application Publication
(10) Pub. No.: US 2011/0129404 A1
(43) Pub. Date: Jun. 2, 2011

(54) SYSTEM AND PROCESS FOR THE PRODUCTION OF POLYCRYSTALLINE SILICON FOR PHOTOVOLTAIC USE

(76) Inventors: Luis Maria Antonello, Rome (IT); Mariano Zarcone, Nettuno Rm (IT)

(21) Appl. No.: 12/997,839

(22) PCT Filed: Jun. 9, 2009
(86) PCT No.: PCT/EP09/57093

§ 371 Date: Feb. 15, 2011

(30) Foreign Application Priority Data
Jun. 13, 2008 (IT) RM2008A000316

(51) Int. Cl. C01B 33/02; F27B 14/10; F27B 14/00; F27B 14/04; F27D 9/00

(52) U.S. Cl. 423/348; 432/156; 432/13

(57) ABSTRACT

The invention relates to an apparatus and process for the production of polycrystalline silicon for photovoltaic applications. The apparatus is characterized in that it comprises of multiple chambers, preferably three, arranged longitudinally one after the other and equipped with: gas immission and extraction means; means for guiding and moving the crucible containing the silicon-based material; insulation and temperature control means; heating means; air-tightness means for each chamber. One of said chambers constitutes the furnace of the apparatus and comprises an area in which the smelting of the material contained in the crucible is carried out, said furnace being equipped with heating means and bearing a heat-stable pedestal, suitable for moving the crucible vertically and thus for introducing it into, or extracting it from the smelting area, respectively.

### FIELD OF THE INVENTION

The present invention relates to an apparatus and process for the production of polycrystalline silicon for photovoltaic use.

In particular, the invention relates to an apparatus in which the loading of the material containing silicon for purification and the extraction of the finished ingots are carried out without any need to switch off the furnace of the apparatus.

### STATE OF PRIOR ART

The typical processes of the thermal cycle for the crystallisation of polycrystalline silicon for photovoltaic use generally involve the following stages:

(i) loading the crucible, generally made of sintered silica, at room temperature, with the silicon feedstock to be crystallised;

(ii) positioning the crucible in the furnace, gradually increasing the temperature above the silicon melting temperature, typically around 1400-1500° C. in inert atmosphere, generally argon;

(iii) proceeding with the cycle following a thermal curve suitable for accomplishing the directional crystallisation of the silicon, possibly carrying out one or more annealing stages;

(iv) allowing the solidification of the smelted material by cooling it in the furnace, again in inert atmosphere;

(v) extracting the crucible from the furnace, generally when a temperature of the order of 200° C. is reached, bringing it down to room temperature and removing the thus obtained silicon solid.

Many furnaces and apparatus are known in the art for carrying out the above-mentioned thermal cycle and for obtaining silicon-based polycrystalline materials for photovoltaic use. In particular, a furnace is described in patent EP 0 186 249 whose crucible containing the silicon feedstock to be re-smelted and re-crystallised, is placed on a cooled pedestal which, when moved vertically, transfers it into the upper part of the furnace to an area which is heated in an inert gas atmosphere at a temperature above the silicon melting temperature.

Subsequently, at the end of the smelting, the temperature is gradually lowered (by reducing the electrical power output delivered) and, as a result of the joint effect of the cooling of the pedestal, the smelted material starts to crystallise from the bottom of the crucible upwards. On completing the crystallisation thermal cycle, the furnace is cooled to 200° C., and then purged of the inert gas therein contained and opened for extraction of the silicon ingot and for loading other material to be crystallised. This operation of cooling down to a temperature of 200° C. is necessary in case of premature opening of the furnace, the graphitic component of the heating part would be exposed to the air and, in the presence of oxygen, would undergo serious deterioration phenomena.

The apparatus thus described also presents other drawbacks, the most important of which are:

The heating components of the furnace are subjected to very wide thermal cycles, ranging from the melting temperature of approximately 1500° C. to the furnace opening temperature of approximately 200° C. and vice versa, which subject the components to considerable high wear, thus reducing its average working life;
The time needed to cool the furnace amounts to approximately 30% of the total time of the production cycle; this time is added to that of the loading and unloading operations, thus prolonging the entire production cycle even more;

In addition, cooling to 200° C. and then reheating in the subsequent cycle, starting from 200° C. rather than from higher temperatures causes inevitable, substantial energy losses.

An improvement in the apparatus is described in patent EP 1 867 759, which, however, does not solve the problems outlined above.

There was therefore the need to reduce production costs, particularly in terms of reducing the times of introduction of the crucible into the furnace and extraction from it.

### SUMMARY OF THE INVENTION

An apparatus that overcomes the above-mentioned drawbacks has now been produced and constitutes an object of the present invention.

The apparatus, according to the present invention, is described in the Claims and in the attached figures.

The apparatus is characterised in that the operations of loading the material to be crystallised and unloading the finished ingots take place without needing to open the furnace to the atmosphere, enabling the graphite components to be left at temperatures well above 200° C., which results in a drastic reduction of the thermal cycle excursion, a gain in terms of process times, a reduction in energy consumption and, additionally, the ability to obtain an end product which is less subject to pollution phenomena and thus substantially purer.

In the apparatus according to the invention, the final cooling of the ingot down to a temperature of approximately 200° C. takes place in an area separate from the furnace. Therefore, the cooling of the ingot can take place in parallel with the loading of a new ingot into the furnace and the time required for said cooling is not added to the total time of the production cycle.

Another object of the invention is the crystallisation process carried out in the apparatus according to the invention.

Additional objects of the invention will be evident from the detailed description of the invention.

### BRIEF DESCRIPTION OF THE FIGURES

FIG. 1 is a schematic perspective view of the apparatus according to the invention.

FIG. 2 is a schematic lateral view of the apparatus according to the invention.

FIG. 3 is a schematic top view of the apparatus according to the invention.

FIG. 4 is a schematic front view of the apparatus according to the invention.

FIG. 5 is the same view as in FIG. 4 with a first crucible in the position of entry into the apparatus.

FIG. 6 is the same view as in FIG. 5 with a second crucible in the position of entry into the apparatus and the first crucible transferred into the first chamber of the apparatus.

FIG. 7 is the same view as in FIG. 6 with a third crucible in the position of entry into the apparatus, the second crucible transferred into the first chamber of the apparatus and the first crucible transferred into the second chamber of the apparatus.

FIG. 8 is the same view as in FIG. 7 with the first crucible transferred to the upper part (area where the smelting takes place) of the second chamber of the apparatus.

FIG. 9 is the same view as in FIG. 8 with the first crucible transferred, on completion of the smelting, to the lower part of the second chamber of the apparatus and aligned along the transfer line of the crucibles.

FIG. 10 is the same view as in FIG. 9 with a fourth crucible in the position of entry into the apparatus, the third crucible transferred into the first chamber of the apparatus, the second crucible transferred into the second chamber of the apparatus and the first crucible transferred into the third chamber of the apparatus.

FIG. 11 is the same view as in FIG. 10 with the second crucible transferred to the upper part (smelting area) of the second chamber of the apparatus.

FIG. 12 is the same view as in FIG. 11 with the second crucible in the process of being transferred to the lower part of the second chamber of the apparatus to be aligned along the transfer line of the crucibles.

FIG. 13 is the same view as in FIG. 12 with a fifth crucible in the position of entry into the apparatus, the fourth crucible transferred into the first chamber of the apparatus, the third crucible transferred into the second chamber of the apparatus, the second crucible transferred into the third chamber of the apparatus, and the first crucible exiting from the apparatus.

FIG. 14 is a perspective section view of the view in FIG. 13 in which the third crucible is transferred into the upper part (smelting area) of the second chamber of the apparatus.

The figures represent a complete, repeatable cycle of the various process stages that can be realised in the apparatus according to the invention.

### DETAILED DESCRIPTION OF THE INVENTION

The apparatus for the preparation of silicon-based polycrystalline materials according to the present invention is characterised in that it comprises multiple chambers, preferably three (1, 2, 3), delimited by curved and/or flat side walls, formed in such a way that a cooling fluid circulates inside them, and arranged longitudinally one after the other and equipped with:
gas immission and extraction means (not shown);
guide (7) and movement means (the latter not shown) for containers or crucibles, generically identified as (6), containing the silicon-based material;
insulation and temperature control means (not shown);
heating means (not shown);
air-tightness means (8) for each chamber,
   one of said chambers being a so-called “hot” chamber in that it is the furnace of the apparatus in which there is an area (4) in which the smelting of the material contained in the crucible (6) takes place, said “hot” chamber or furnace being equipped with heating means (not shown) and bearing a heat-stable pedestal (5), which supports the crucible (6), suitable for vertically moving the crucible and then carrying it into or extracting it from the smelting area (4), respectively. Furnace set-ups that could adequately constitute chamber (2) and then be combined with chambers (1) and (3) are described in patents EP 0 186 249 and EP 1 867 759.

With particular reference to the attached figures, which illustrate a preferred embodiment of the invention, the apparatus comprises a first chamber (1) and a third chamber (3), each bound by side walls (1′) and (3′), respectively, designed in such a way that a cooling fluid circulates inside them. The first is a so-called “loading” and preheating chamber, equipped with an opening to the outside and with another opening to the second chamber or “hot” chamber. The third is a so-called “unloading” and cooling chamber, equipped in turn with an opening to the “hot” chamber and another opening to the outside.

All the chambers (1, 2, 3) are vacuum sealed and are equipped, on the openings, with means for ensuring air-tightness (8), for example air-tightness bulkheads.

Chamber (2), interposed longitudinally between the first and third chambers, communicating with them via the openings and capable of being insulated by means of the air-tightness means (8), is conformed such as to have a central body, generically cylindrical, with its axis orthogonal to the longitudinal axis of the apparatus connected up to the first and third chambers via the longitudinal connecting walls (2′). Said central body is equipped with cylindrical walls (2″), with an upper cover (2′″) and a lower cover (2″″), both of which can be opened to permit easy maintenance, the lower cover (2″″) being additionally equipped with a central hole for passage of the heat-stable pedestal (5) for raising or lowering the crucible (6). The crucible (6) is positioned on the pedestal (5) to be transferred vertically into the “hot” chamber and housed in the smelting area (4). The “hot” chamber is generally made with stainless steel walls within which a cooling fluid circulates. The actual silicon smelting area (4) is placed in the upper part of the “hot” chamber. Said area (4) is insulated with refractory material and heated by means of graphite resistors. As can be seen in the figures, the crucible (6) is placed on the thermostated pedestal (5). The vertical excursion of the pedestal is such as to carry the crucible (6) into the smelting area (4). As shown in the figure, the right-hand side of the hot chamber (2) is connected, via the air-tightness means (8), to the loading chamber (1), while the left-hand side is connected to the cooling and unloading chamber (3). The loading and unloading chambers typically have a volume similar to that of the crucible (6), while the “hot” chamber (2) has at least twice the volume of the crucible.

By means of the guides (7) the crucible (6) is transferred from the outside to chamber (1), then to the second chamber (2), then to chamber (3) and is then transferred to outside, passing through the openings that make the various chambers to communicate, by opening and closing the air-tightness means (8).

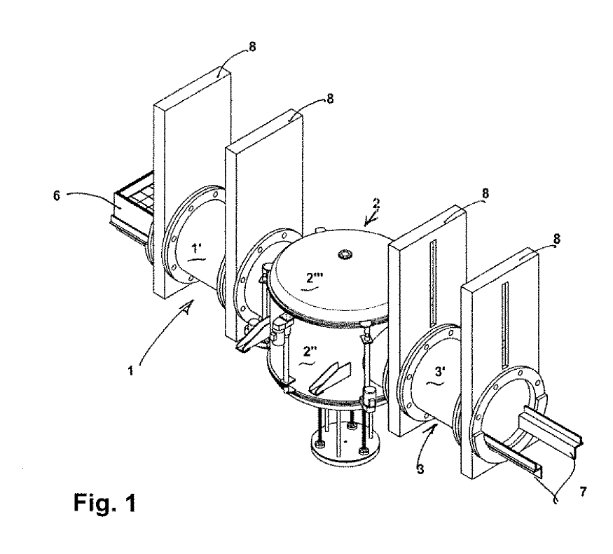

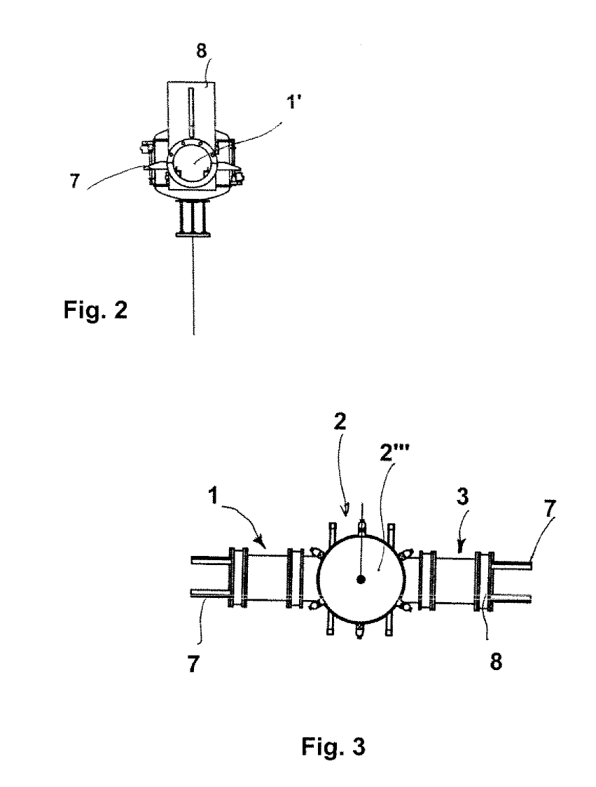

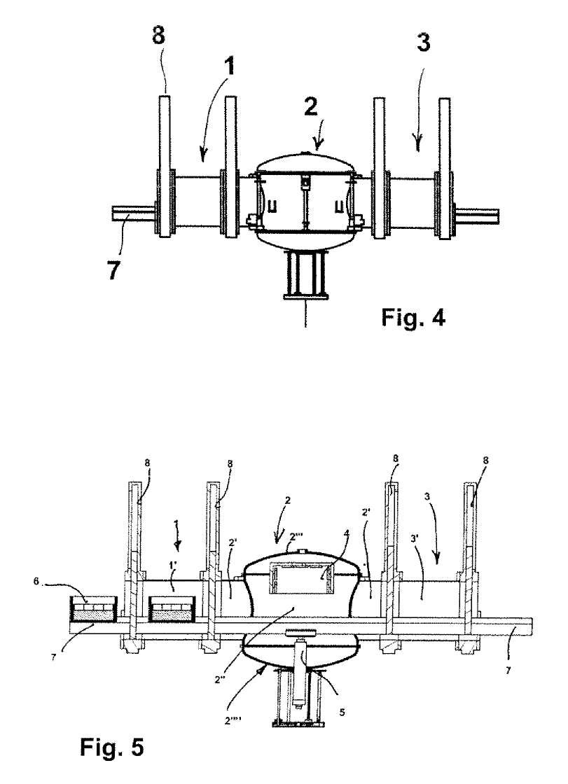

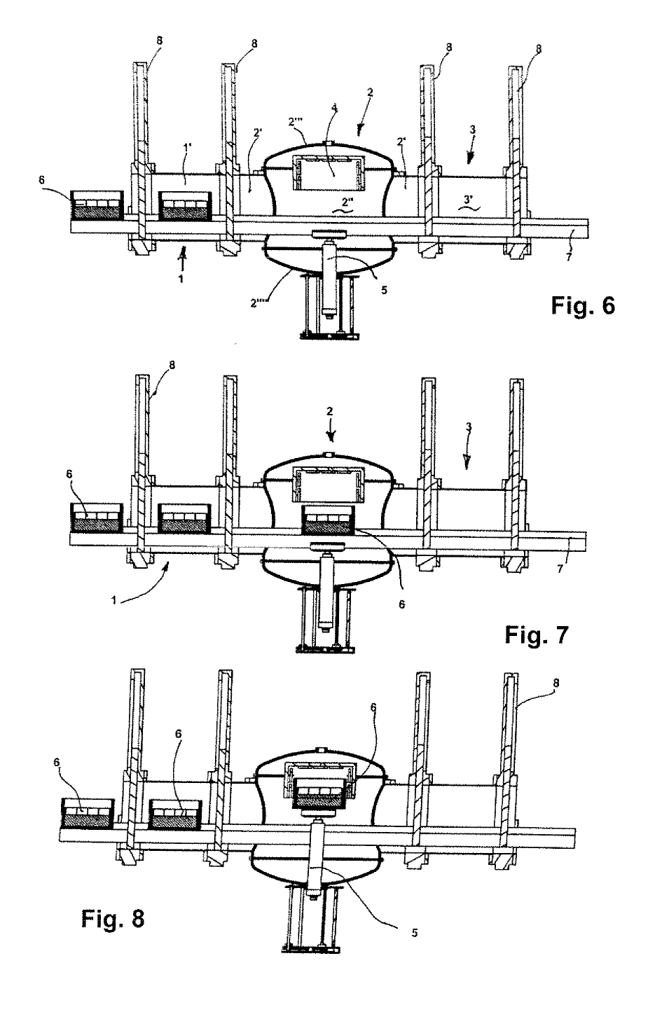

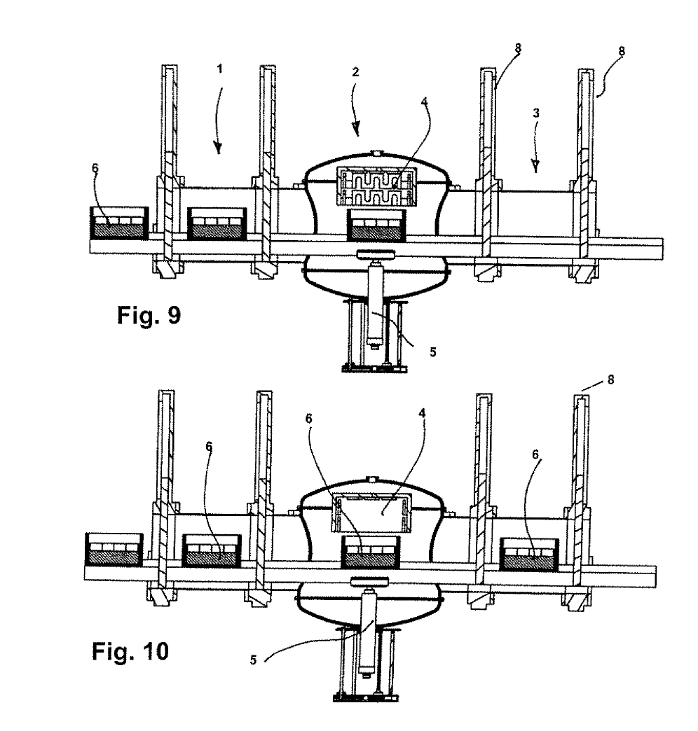

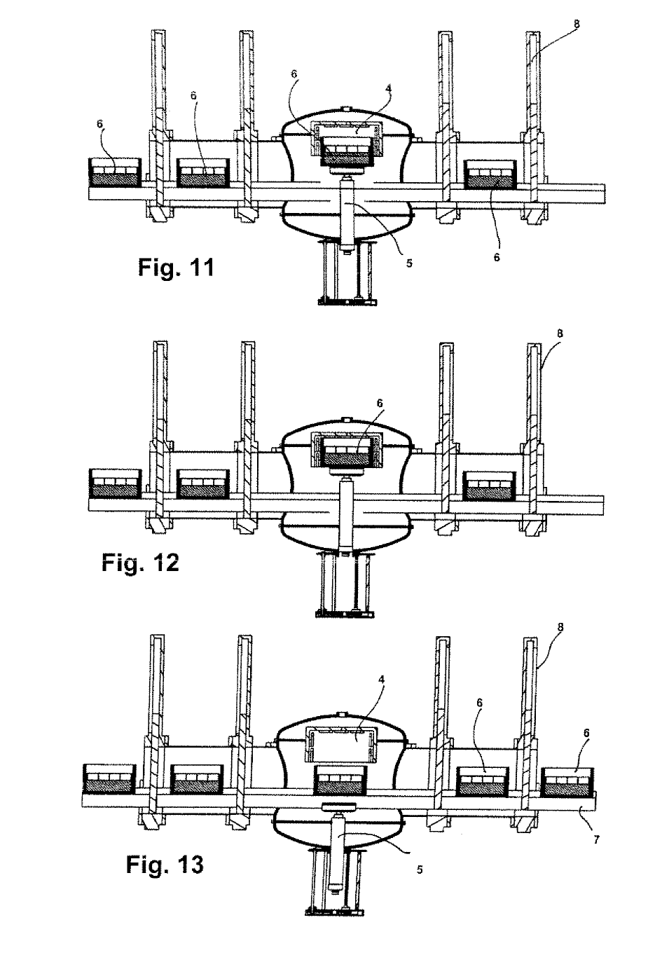

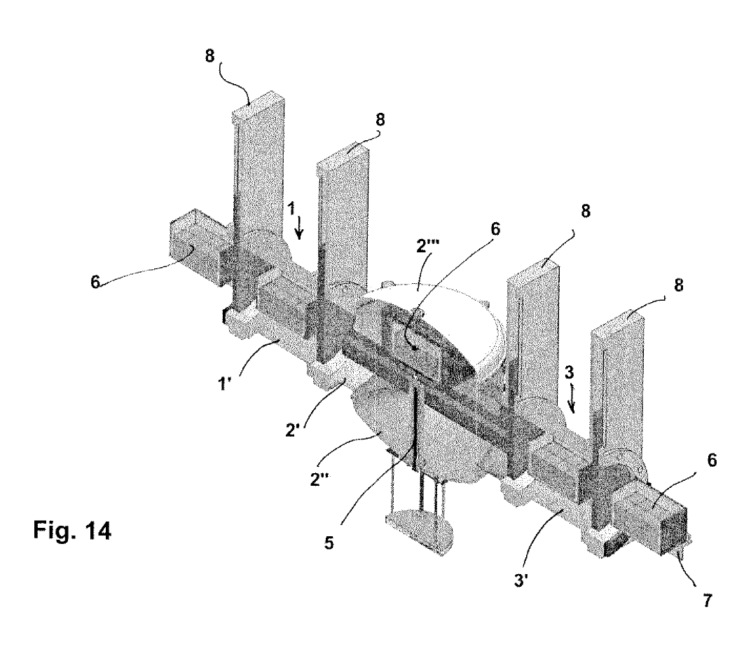

With the set-up of the chambers illustrated in FIGS. 1-14, the following operations are performed:

(a) The loading chamber (1) is opened to the outside and the air-tightness means (8) hermetically seal the opening that connects chamber (1) to chamber (2). First moving means position the crucible (6) on the guides (7), and additional moving means transfer it into chamber (1), after which the air-tightness means (8) hermetically seal off access to the outside. Access to the hot chamber (2) is still closed. The air is extracted from the loading chamber (1) by means of vacuum pumps; on reaching the desired vacuum, typically around 10⁻² bar, an inert gas, generally argon, is introduced to create an inert atmosphere, typically at a pressure of 0.1-0.3 bar;

(b) The air-tightness means (8) are opened to permit access and transportation of the crucible (6) from the loading chamber (1) to the hot chamber (2); further moving and guide means position the crucible (6) on the pedestal (5), which is in the fully lowered position;

(c) The air-tightness means (8) hermetically seal the hot chamber (2); lifting means raise the pedestal (5) to bring the crucible (6) into the smelting area (4). Heating means raise the temperature inside the furnace in order to smelt and then crystallise the silicon according to the thermal profile and the conditions required for the smelting and crystallisation process. On completion of these operations, lowering means lower the pedestal (5) to bring the crucible (6) containing the ingot of crystallised silicon back to the level of the moving and guide means suitable for transferring said crucible from chamber (2) to the cooling chamber (3), the atmosphere of which has previously been rendered similar (in terms of temperature and inert gas) to that of chamber (2) by means of the heating means, the pumps and the air-tightness means (8). After this, the air-tightness means (8) are opened, thus permitting communication between the two chambers, and the moving and guide means transfer the ingot (6) into chamber (3), which, at the end of the operation, is insulated by means of the air-tightness devices (8) and the crucible (6) is left to cool;

(d) meanwhile, with the same implementation modalities, a new crucible loaded with silicon feedstock to be crystallised is brought from the outside into the loading chamber (1) and then transferred, as previously described, into chamber (2) to be subjected to the smelting and crystallisation cycle. During this period of time, of the order of tens of hours, the preceding ingot, placed in the cooling chamber (3), will have had time to cool down completely to room temperature and can therefore be unloaded to the outside;

(e) the air-tightness means (8) are then opened and the guide and moving means unload the crucible (6) containing the now cold ingot to the outside; chamber (3) is closed again by means of the air-tightness means (8), emptied of air by means of vacuum pumps, and filled with inert gas (argon) to recreate the milieu of the hot chamber (2).

At this point, chamber (3) is ready to receive another crucible from the hot chamber (2) and thus continue the cycle.

As can be easily inferred from the aforesaid operations, the furnace is never opened to the outside and its internal milieu is always maintained inert thanks to the presence of the air-tightness means (8) which insulate it from the external environment and connect it to chambers (1) and (3) only when the latter have been brought to the same temperature and inert gas milieu conditions. This makes it possible to limit possible sources of pollution and to obtain silicon of a high grade of purity for photovoltaic use. In addition, process times are shortened, generally by about twenty hours, corresponding substantially to the time necessary for cooling the crystallised ingot, the cooling no longer being done in the furnace but in chamber (3) adjacent to it.

The following example is to be regarded as illustrative and not limitative of the scope of the invention.

### EXAMPLE

An apparatus produced as illustrated in the figures and described above is used. A crucible (6) containing silicon of solar purity (98%) is placed in the loading chamber (1). After using pumps to produce a vacuum of the order of 10⁻⁴ millibar, the chamber is filled with argon and brought to a pressure of 0.3 bar. Access to chamber (2) is opened and the crucible (6) is transferred onto the thermostated pedestal (5). Access to the hot chamber (2) is closed again by means of the air-tight bulkhead (8) and the pedestal (5) travels vertically bringing the crucible (6) into the smelting area (4). The crucible (6) is heated to a temperature of 1500° C. with the result that the silicon it contains melts. Since a cooling fluid circulates in the pedestal (5) a temperature gradient is created inside the crucible (6) along its vertical axis. When all the silicon is smelted, the temperature in the smelting zone (4) is reduced by 0.5° C. per hour so that, as a result of the combined effect of this temperature reduction and of the cooling of the pedestal, the crystallisation process of the silicon contained in the crucible (6) starts from the base and proceeds upwards. At the same time as the temperature reduction, during the crystallisation phase, the pedestal (5) is lowered at a rate equal approximately to the crystallisation rate (from 3 to 30 mm/hr). By doing this, the spatial position of the separation surface between molten silicon and solid crystalline silicon is maintained constant. On completing the crystallisation process, the pedestal (5) is rapidly lowered into the bottom part of the hot chamber (2) and finally transferred into the cooling and unloading chamber (3).

After closing access to the cooling chamber (3), the hot chamber (2) is ready to accept another crucible from chamber (1) containing the silicon to be smelted and crystallised according to the modalities described above. Meanwhile, the crucible placed inside the cooling chamber (3) is cooled in approximately 20 hours and can be unloaded to the outside. The cooling chamber (3) is thus opened and the ingot is unloaded. The cooling chamber (3) is then closed again. In it, with the aid of the air-tightness bulkheads (8), a vacuum is produced and, on reaching a value of approximately 10⁻⁴ bar, the chamber is filled with argon to a pressure of 0.3 bar. At this point it is ready to receive a new ingot from the hot chamber (2) and the cycle proceeds in a semicontinuous manner.

The polycrystalline silicon obtained with the system according to the invention is of excellent quality for photovoltaic use; the mean lifetime of the minority carriers measured in it is greater than 2 microseconds with a mean value of around 5 microseconds (SEMI MF28 method). Therefore, the material is well within the specifications required of the manufacturers of photovoltaic cells which prescribe that the lifetime should be greater than 2 microseconds.

1. An apparatus for production of silicon-based polycrystalline materials comprising:
a plurality of chambers, wherein said chambers are positioned longitudinally and delimited by curved and/or flat side walls, designed in such a way that a cooling fluid circulates within said chambers and arranged longitudinally one after the other;
a gas immission and extraction compartment;
a guide;
a movable crucible containing the silicon-based material;
an insulation and temperature control compartment;
a heater; and
an air-tightness compartment for each chamber;
one of said chambers comprising a furnace of a system containing a zone in which smelting of the material contained in the crucible is accomplished, said furnace, being equipped with the heater and bearing a heat-stable pedestal, equipped with a compartment for vertical movement to introduce the crucible into the zone or to extract the crucible from the zone.

2. The apparatus according to claim 1, wherein said plurality of chambers comprises: a first chamber and a third chamber, each delimited by side walls, between which a second chamber is interposed; said first chamber being equipped with an opening to the outside and with an opening to the second chamber; said third chamber being equipped with an opening to the second chamber and with an opening to the outside, all three chambers being vacuum sealed and equipped, on the openings, with the air-tightness compartment.

3. The apparatus according to claim 2, wherein the second chamber is interposed longitudinally between the first and third chambers, communicating with the second and third chambers through openings and insulatable by the air-tightness compartment, said second chamber presenting a conformation such as to have a central body, with an axis orthogonal to a longitudinal axis of the system, connected to the first and third chambers via longitudinal connecting walls; said central body being equipped with cylindrical walls, a top cover and a bottom cover, both of said covers can be opened, the bottom cover being equipped with a central hole for the passage of the heat-stable pedestal.

4. The apparatus according to claim 2, wherein the second chamber comprises stainless steel walls within which a cooling fluid circulates.

5. The apparatus according to claim 2, wherein, in an upper part of the second chamber there is the zone for the smelting of the silicon, said zone being insulated with a refractory material and heated by graphite resistors.

6. The apparatus according to claim 2, wherein said first and third chambers have a volume similar to that of the crucible, while said second chamber has a volume which is at least twice that of the crucible.

7. A process for smelting and crystallization of a material containing silicon to be carried out in the apparatus according to claim 1, comprising the following stages:
(a) loading the crucible in which the material containing silicon is present onto the guide, inserting said the crucible loaded onto the guide in a first chamber and sealing said first chamber hermetically with the air-tightness compartment; extracting the air present in said first chamber by vacuum pumps until a desired vacuum is obtained, and introducing an inert gas until a pressure of approximately 0.1-0.3 bar is reached;
(b) connecting up the first chamber to a second chamber; transferring the crucible onto the pedestal, which is in a fully lowered position;
(c) sealing the hot second chamber hermetically with the air-tightness compartment; raising the pedestal vertically to transfer the crucible into the zone; smelting and then crystallizing the silicon, after which lowering the pedestal to bring the crucible back to a level of a third chamber, whose atmosphere has previously been rendered similar to that of the second chamber; establishing communication between the second chamber and the third chamber, transferring the crucible into the third chamber, then re-sealing the third chamber hermetically with the air-tightness compartment and leaving the crucible to cool;
(d) meanwhile, bringing a new crucible loaded with silicon to be crystallized according to the conditions of stage a) from the outside to the first chamber, then transferring the new crucible from the first chamber to the second chamber according to the conditions of stage b), subjecting the new crucible from the second chamber to the smelting and crystallization cycle according to the conditions of stage c), while, simultaneously, the previous crucible, housed in the third chamber, and now cooled, is unloaded to the outside after replacing the inert atmosphere with air, with the aid of the pumps and the air-tightness compartment;
(e) reclosing the third chamber and emptying the reclosed third chamber of air, introducing inert gas to recreate a milieu of the second chamber so that said third chamber is in a condition to receive another crucible from the hot second chamber and then continue at least part of the process.

8. Polycrystalline silicon for photovoltaic use characterised by a lifetime of the minority carriers measured in it greater than 2 microseconds with a mean value of around 5 microseconds (SEMI MF28 method).

9. The apparatus according to claim 3, wherein said central body is substantially cylindrical.

10. The process according to claim 7, wherein the desired vacuum is about 10⁻² bar.

11. The process according to claim 7, wherein the inert gad is argon.
